(19) United States
(12) Patent Application Publication
(10) Pub. No.: US 2026/0112946 A1
(43) Pub. Date: Apr. 23, 2026

(54) DRIVE DEVICE

(71) Applicant: TOYOTA JIDOSHA KABUSHIKI KAISHA, Toyota-shi (JP)

(72) Inventor: Shinsuke AOYAGI, Isehara-shi (JP)

(73) Assignee: TOYOTA JIDOSHA KABUSHIKI KAISHA, Toyota-shi (JP)

(21) Appl. No.: 19/240,638

(22) Filed: Jun. 17, 2025

(30) Foreign Application Priority Data
Oct. 17, 2024 (JP) 2024-182200

(51) Int. Cl. H02K 11/33

(52) U.S. Cl. CPC H02K 11/33

(57) ABSTRACT

The drive device switches between Y driving in which the changeover switch is turned off, the other end side of the three-phase open winding is neutralized by the second inverter, and the motor is driven by the switching of the first inverter, and H driving in which the changeover switch is turned on and the motor is driven by the switching of the first and second inverters. In this case, the Y drive gain and the H drive gain are estimated, and when the value obtained by subtracting the H drive gain from the Y drive gain is larger than the first threshold value during the Y drive, switching is made to the H drive, and when the value obtained by subtracting the Y drive gain from the H drive gain is larger than the second threshold value during the H drive, switching is made to the Y drive.

### CROSS-REFERENCE TO RELATED APPLICATION

This application claims priority to Japanese Patent Application No. 2024-182200 filed on Oct. 17, 2024. The disclosure of the above-identified application, including the specification, drawings, and claims, is incorporated by reference herein in its entirety.

### BACKGROUND

### 1. Technical Field

The present disclosure relates to a drive device.

### 2. Description of Related Art

Conventionally, there has been proposed a drive device (see Japanese Unexamined Patent Application Publication No. 2018-14829 (JP 2018-14829 A), for example) including: a power storage device, a motor having a three-phase open winding, a first inverter connected to a power line to which the power storage device is connected and connected to one end side of the three-phase open winding, a second inverter connected to the power line on an opposite side of the power storage device from the first inverter and connected to the other end side of the three-phase open winding, a changeover switch provided in the power line between the first and second inverters, and a capacitor connected to the power line on a side of the first inverter from the changeover switch. Such a drive device switchably executes a Y drive and a Δ drive (H drive). In the Y drive, the changeover switch is turned off, the other end side of the three-phase open winding is neutralized by the second inverter, and the motor is driven by the first inverter unit. In the Δ drive, the changeover switch is turned on, and the motor is driven by the first and second inverter units.

### SUMMARY

In addition to the hardware configuration of the drive device described above, there may be further provided a second capacitor connected to the power line on a side of the first inverter from the changeover switch. In this case, the total capacitance is different between the Y drive and the H drive. Therefore, in the current drive among the Y drive and the H drive, there is a possibility that the gain of the current amplitude on the power storage device side with respect to the current amplitude on the side of a drive unit including the motor, the first and second inverters, the changeover switch, the capacitor, and the second capacitor becomes relatively large.

The drive device according to the present disclosure has a main object of suppressing the gain of the current amplitude on the power storage device side with respect to the current amplitude on the drive unit side becoming relatively large.

In order to achieve the above main object, the drive device according to the present disclosure adopts the following measures.

An aspect of the present disclosure provides a drive device including:
a power storage device;
a drive unit including a motor having a three-phase open winding, a first inverter connected to a power line to which the power storage device is connected and connected to one end side of the three-phase open winding, a second inverter connected to the power line on an opposite side of the power storage device from the first inverter and connected to the other end side of the three-phase open winding, a changeover switch provided in the power line between the first and second inverters, a first capacitor connected to the power line on a side of the first inverter from the changeover switch, and a second capacitor connected to the power line on a side of the second inverter from the changeover switch; and
a control device that switchably executes a Y drive, in which the changeover switch is turned off, the other end side of the three-phase open winding is neutralized by the second inverter, and the motor is driven by switching the first inverter, and an H drive, in which the changeover switch is turned on and the motor is driven by switching the first and second inverters, in which
the control device estimates a Y drive gain and an H drive gain that are current gains of a frequency of a main component that affects a current amplitude of the power storage device in the Y drive and the H drive, switches to the H drive when a value obtained by subtracting the H drive gain from the Y drive gain is larger than a first threshold value during the Y drive, and switches to the Y drive when a value obtained by subtracting the Y drive gain from the H drive gain is larger than a second threshold value during the H drive.

The drive device according to the present disclosure switchably executes the Y drive and the H drive. In the Y drive, the changeover switch is turned off, the other end side of the three-phase open winding is neutralized by the second inverter, and the motor is driven by switching the first inverter. In the H drive, the changeover switch is turned on, and the motor is driven by switching the first and second inverters. In this case, a Y drive gain and an H drive gain that are current gains of the frequency of the main component that affects the current amplitude of the power storage device in the Y drive and the H drive are estimated. Then, switching is made to the H drive when a value obtained by subtracting the H drive gain from the Y drive gain is larger than a first threshold value during the Y drive, and switching is made to the Y drive when a value obtained by subtracting the Y drive gain from the H drive gain is larger than a second threshold value during the H drive. Consequently, it is possible to suppress the gain of the current amplitude on the power storage device side with respect to the current amplitude on the drive unit side becoming relatively large.

In the drive device according to the present disclosure, the control device may set the frequency of the main component based on an operating point of the motor and/or a control mode of the first and second inverters. The frequency of the main component may be set from twice a carrier frequency of the first and second inverters, three times an electrical frequency of the motor plus or minus the carrier frequency, and six times the electrical frequency, for example.

In the drive device according to the present disclosure, the control device may estimate the Y drive gain and the H drive gain by applying the frequency of the main component to a predetermined relationship between a frequency and a gain of the Y drive and the H drive.

In the drive device according to the present disclosure, the first and second threshold values may be greater than a value of zero.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a drive device according to an embodiment of the present disclosure;

FIG. 2 is a flowchart illustrating an exemplary process routine; and

FIG. 3 is an explanatory diagram illustrating an example of a gain estimation map.

### DETAILED DESCRIPTION OF EMBODIMENTS

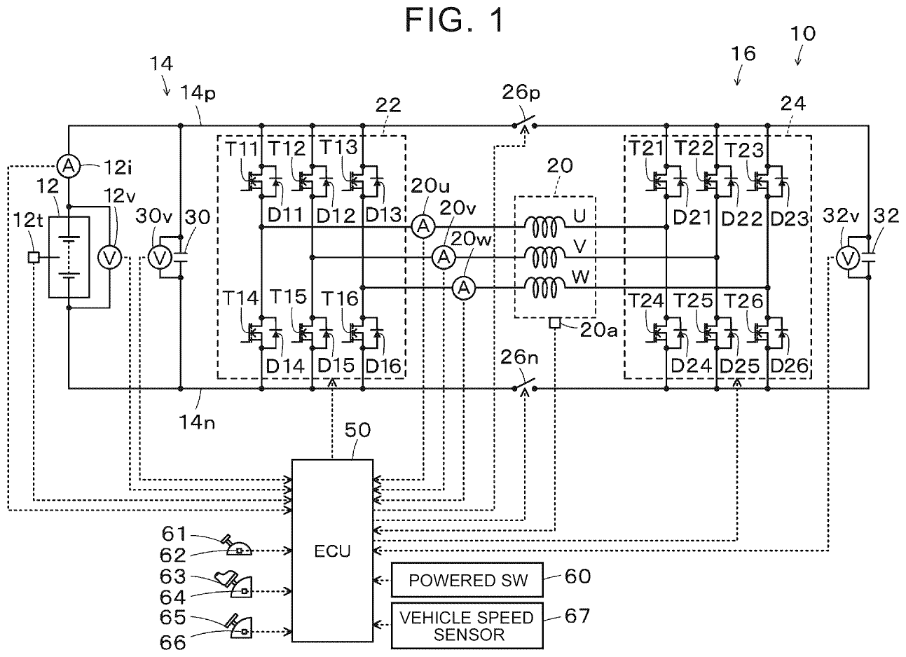

Embodiments for carrying out the present disclosure will be described with reference to the drawings. FIG. 1 is a schematic configuration diagram of a drive device 10 according to an embodiment of the present disclosure. As illustrated, the drive device 10 of the embodiment includes a battery 12 as a power storage device, a drive unit 16, and an electronic control unit (hereinafter, referred to as “ECU”) 50 as a control device. The drive device 10 is mounted on a battery electric vehicle, a hybrid electric vehicle, fuel cell electric vehicle, or the like.

The battery 12 is configured as, for example, a lithium-ion secondary battery or a nickel-hydrogen secondary battery, and is connected to the power line 14 (the positive-electrode-side line 14p and the negative-electrode-side line 14n).

The drive unit 16 includes a motor 20, first and second inverters 22 and 24, a positive-electrode-side switch 26p and a negative-electrode-side switch 26n as changeover switches, and first and second capacitors 30 and 32.

The motor 20 is configured as a three-phase AC motor, and includes a rotor in which a permanent magnet is embedded in a rotor core, and a stator in which a three-phase (U-phase, V-phase, and W-phase) coil (three-phase open winding) is wound around the stator core. The rotor is connected to a drive shaft connected to the drive wheels via a differential gear.

The first inverter 22 is connected to the power line 14 and is connected to one end side of the three-phase coil of the motor 20. The second inverter 24 is connected to a side of the power line 14 opposite to the battery 12 with respect to the first inverter 22, and is connected to the other end side of the three-phase coil of the motor 20. Each of the first and second inverters 22 and 24 includes six transistors T11 to T16, T21 to T26 as a plurality of switching elements. Further, the first and second inverters 22 and 24 each include six diodes D11 to D16, D21 to D26 connected in parallel to the six transistors T11 to T16, T21 to T26. As the transistor T11 to T16, T21 to T26, for example, an MOSFET, an IGBT, or the like is used. The transistors T11 to T16, T21 to T26 are arranged in pairs so as to be on the source-side and the sink-side with respect to the positive-electrode-side line 14p and the negative-electrode-side line 14n, respectively. Each of the connecting points of the two transistors that form the pair of the transistors T11 to T16 is connected to one end of each of the three-phase coils of the motor 20. Each of the connecting points of the two transistors that form the pair of the transistors T21 to T26 is connected to each of the other end sides of the three-phase coils of the motor 20. Hereinafter, the transistor T11 to T13 may be referred to as a “first upper arm”, the transistor T14 to T16 may be referred to as a “first lower arm”, the transistor T21 to T23 may be referred to as a “second upper arm”, and the transistor T24 to T26 may be referred to as a “second lower arm”.

The positive-electrode-side switch 26p and the negative-electrode-side switch 26n are provided between the first and second inverters 22 and 24 of the positive-electrode-side line 14p and the negative-electrode-side line 14n, respectively. As the positive-electrode-side switch 26p and the negative-electrode-side switch 26n, for example, a semi-conductor switch, an insulated switch, or the like is used.

The first capacitor 30 is connected to the first inverter 22 side with respect to the positive side switch 26p and the negative side switch 26n in the power line 14. The second capacitor 32 is connected to the second inverter 24 side with respect to the positive side switch 26p and the negative side switch 26n in the power line 14. In the embodiment, the battery 12, the first capacitor 30, the first inverter 22, the second inverter 24, and the second capacitor 32 are connected to the power line 14 in this order from the left side of FIG. 1.

ECU 50 includes a microcomputer having a CPU, ROM, RAM, a flash memory, an input/output port, and a communication port, various driving circuitry, and various logic IC. ECU 50 receives signals from various sensors. For example, ECU 50 receives the voltage Vb of the battery 12 from the voltage sensor 12v, the current Ib of the battery 12 from the current sensor 12i, and the temperature Tb of the battery 12 from the temperature sensor 12t. ECU 50 also receives the rotational position θm of the rotor of the motor 20 from the rotational position sensor 20a and the phase current Iu, Iv, Iw of each phase of the motor 20 from the current sensor 20u, 20v, 20w. The voltage VH of the first capacitor 30 from the voltage sensor 30v and the voltage VL of the second capacitor 32 from the voltage sensor 32v are also inputted to ECU 50. ECU 50 also receives an on-off signal from the power switch 60, a shift position SP which is an operating position of the shift lever 61 from the shift position sensor 62, an accelerator operation amount Acc which is a depression amount of the accelerator pedal 63 from the accelerator pedal position sensor 64, a brake pedal position BP which is a depression amount of the brake pedal 65 from the brake pedal position sensor 66, and a vehicle speed V from the vehicle speed sensor 67.

Various control signals are outputted from ECU 50. For example, a control signal to the transistor T11 to T16 of the first inverter 22, the transistor T21 to T26 of the second inverter 24, the positive-electrode-side switch 26p, and the negative-electrode-side switch 26n is outputted from ECU 50. ECU 50 calculates the power storage ratio SOC of the battery 12 based on the integrated value of the current Ib of the battery 12, and calculates the electric angle θe, the rotational speed Nm, and the electric frequency fm of the motor 20 based on the rotational position θm of the rotor of the motor 20.

In the drive device 10 of the embodiment, ECU 50 sets a required torque Td* required for traveling based on the accelerator operation amount Acc and the vehicle speed V. Then, the torque command Tm* of the motor 20 is set so as to travel according to the set required torque Td*. Further, the first and second inverters 22 and 24, the positive-electrode-side switch 26p, and the negative-electrode-side switch 26n are controlled by Y-drive or H-drive based on the set torque command Tm.

In the Y drive, the positive-electrode-side switch 26p and the negative-electrode-side switch 26n are turned off, and the second inverter 24 side is neutralized with respect to the three-phase coil of the motor 20 by the second inverter 24, and the first inverter 22 (the transistor T11 to T16) is switched and driven. Neutralization of the motor 20 closer to the second inverter 24 than the three-phase coil is performed by turning on one of the second upper arm (transistor T21 to T23) and the second lower arm (transistor T24 to T26) of the second inverter 24 and turning off the other. Since only the first capacitor 30 functions among the first and second capacitors 30 and 32, the capacitor capacitance Cd of the entire drive unit 16 becomes the capacitance C1 of the first capacitor 30.

In the H drive, the positive-electrode-side switch 26p and the negative-electrode-side switch 26n are turned on, and the first and second inverters 22 and 24 (transistor T11 to T16, T21 to T26) are switched and driven. Since the first and second capacitors 30 and 32 function, the capacitor capacitance Cd of the entire drive unit 16 is a combined capacitance of the capacitance C1, C2 of the first and second capacitors 30 and 32.

In the embodiment, the switching driving of the first inverter 22 in the Y driving and the switching driving of the first and second inverters 22 and 24 in the H driving are performed by switching the respective control modes. The control modes are a pulse-width modulation control mode (sinusoidal PWM control mode) using a carrier-frequency fc, an overmodulation PWM control mode, and a square-wave control mode.

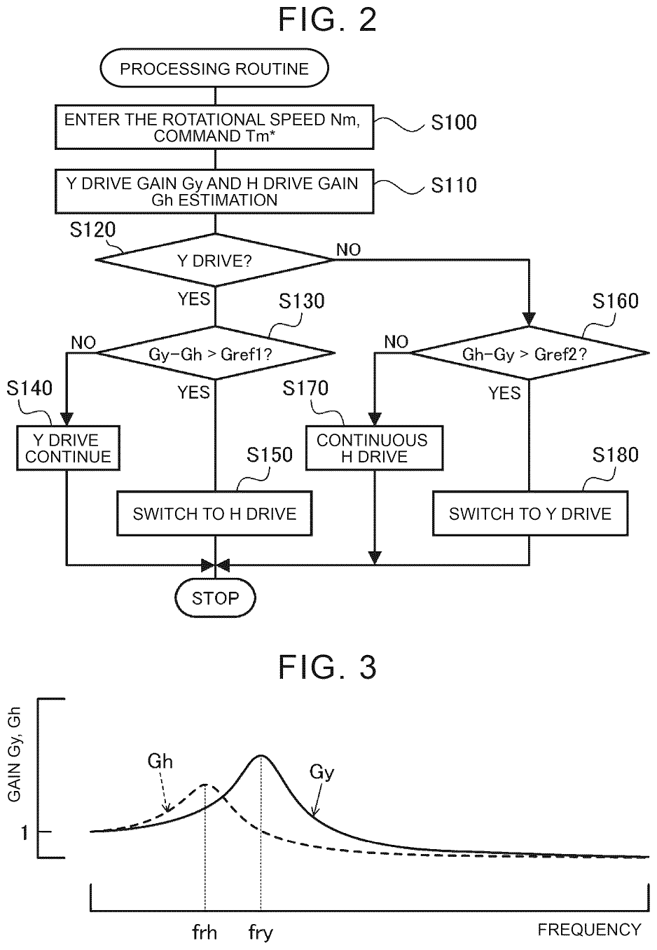

Next, the operation of the drive device 10 of the embodiment, in particular, the switching between the Y drive and the H drive will be described. FIG. 2 is a flowchart illustrating a process routine executed by ECU 50. This routine is repeatedly executed.

When this routine is executed, ECU 50 first inputs the rotational speed Nm of the motor 20, the torque command Tm*, and the like (S100). Subsequently, the Y drive gain Gy and the H drive gain Gy are estimated (S110). Here, the Y drive gain Gy and the H drive gain Gy are current gains (gains of current amplitudes on the battery 12 side with respect to current amplitudes on the drive unit 16 side) in the frequency fbi of the main components that affect the current amplitudes of the battery 12 in the Y drive and the H drive, respectively.

Here, the frequency fbi of the main component, for example, based on the operating point of the motor 20 (torque command Tm* and rotational speed Nm), can be set any of the following frequencies: 2 times the carrier frequency fc of the first and second inverters 22 and 24, 3 times the electric frequency fm of the carrier frequency fc±motor 20, 6 times the electric frequency fm. The principal component can be set using, for example, the operating point of the motor 20 and the principal component map. The principal component map is determined in advance by an experiment, an analysis, or the like as a relationship between the operating point of the motor 20 and the principal component. This can be obtained by applying the operating point of the motor 20 to the principal component map and deriving the corresponding principal component. Then, the frequency fbi of the principal component can be obtained based on the principal component.

The Y drive gain Gy and the H drive gain Gy can be estimated using, for example, the frequency fbi of the principal component and the gain estimation map. The gain estimation map is determined in advance as a relation between the frequency fbi of the principal component, the Y drive gain Gy, and the H drive gain Gy. FIG. 3 is an explanatory diagram illustrating an example of a gain estimation map. In the drawing, “fry” and “frh” are resonant frequencies in the Y drive and the H drive, respectively, and are obtained by 1/(2π·√(Ld·Cd)) using the inductance Ld and the capacitor capacitance Cd of the entire drive unit 16. These can be obtained by applying the frequency fbi of the principal components to the gain estimation map and deriving the corresponding Y drive gain Gy and H drive gain Gy.

When the Y drive gain Gy and the H drive gain Gy are estimated in this way, it is determined which of the Y drive and the H drive is being performed (S120). When it is determined that the Y drive is being executed, the value obtained by subtracting the H drive gain Gh from the Y drive gain Gy is compared with the threshold Gref1 (S130). Here, the threshold Gref1 may be a value 0 or a positive value. When it is determined that the value obtained by subtracting the H drive gain Gh from the Y drive gain Gy is equal to or less than the threshold Gref1, it is determined that the Y drive is continued (S140), and this routine is ended. On the other hand, when it is determined that the value obtained by subtracting the H drive gain Gh from the Y drive gain Gy is larger than the threshold Gref1, it is determined that the drive is switched from the Y drive to the H drive (S150), and the routine is ended. In this way, by switching from the Y drive to the H drive, it is possible to suppress the gain of the current amplitude on the battery 12 side with respect to the current amplitude on the drive unit 16 side from being relatively large in the Y drive.

When it is determined that the H drive is executed in S120, the value obtained by subtracting the Y drive gain Gy from the H drive gain Gh is compared with the threshold Gref2 (S160). Here, the threshold Gref2 may be a value 0 or a positive value. The threshold Gref2 may be the same as or different from the threshold Gref1. When it is determined that the value obtained by subtracting the Y drive gain Gy from the H drive gain Gh is equal to or less than the threshold Gref2, it is determined that the H drive is continued (S170), and this routine is ended. On the other hand, when it is determined that the value obtained by subtracting the Y drive gain Gy from the H drive gain Gh is larger than the threshold Gref2, it is determined that the driving is switched from the H drive to the Y drive (S180), and this routine is ended. In this way, by switching from the H drive to the Y drive, it is possible to suppress the gain of the current amplitude on the battery 12 side with respect to the current amplitude on the drive unit 16 side from being relatively large by the H drive. When a positive value is used as the threshold Gref1, Gref2, frequent switching (hunting) between the Y drive and the H drive can be suppressed as compared with the case where the value 0 is used.

In the drive device 10 of the above-described embodiment, the Y drive gain Gy and the H drive gain Gy are estimated. Then, when the value obtained by subtracting the H drive gain Gy from the Y drive gain Gh during the Y driving is larger than the threshold Gref1, the driving is switched from the Y driving to the H driving, and when the value obtained by subtracting the Y drive gain Gy from the H drive gain Gh during the H driving is larger than the threshold Gref2, the driving is switched from the H driving to the Y driving. As a result, it is possible to suppress the gain of the current amplitude on the battery 12 side relative to the current amplitude on the drive unit 16 side from being relatively large.

In the above-described embodiment, the frequency fbi of the main component is set from twice the carrier frequency fc of the first and second inverters 22 and 24, three times the electric frequency fm of the carrier frequency fc±the motor 20, and six times the electric frequency fm, based on the operating point of the motor 20 (the torque command Tm* and the rotational speed Nm), but the present disclosure is not limited thereto. For example, instead of the operating point of the motor 20, the frequency fbi of the main component may be set based on the control modes of the first and second inverters 22 and 24. In this case, when the control mode of the first and second inverters 22 and 24 is the sinusoidal PWM control mode, the frequency component having the largest frequency component among twice the carrier frequency fc and three times the carrier frequency fc±the electric frequency fm may be set as the frequency fbi of the main component. When the control mode is the overmodulation PWM control mode or the square-wave control mode, six times the electric frequency fm may be set as the frequency fbi of the main component. The frequency fbi of the main component may be set based on the operating point of the motor 20 and the control modes of the first and second inverters 22 and 24.

The correspondence between the main elements of the embodiments and the main elements of the disclosure described in the column of the means for solving the problem will be described. In the embodiment, the battery 12 corresponds to the “power storage device”, the motor 20 corresponds to the “motor”, the first inverter 22 corresponds to the “first inverter”, the second inverter 24 corresponds to the “second inverter”, the positive-electrode-side switch 26p and the negative-electrode-side switch 26n correspond to the “changeover switch”, the first capacitor 30 corresponds to the “first capacitor”, the second capacitor 32 corresponds to the “second capacitor”, and ECU 50 corresponds to the “control device”.

The correspondence between the main elements of the embodiment and the main elements of the disclosure described in the section of the means for solving the problem is an example for specifically explaining the embodiment of the disclosure described in the section of the means for solving the problem. The correspondence between the main elements of the embodiments and the main elements of the disclosure is not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a drive device and the like.

What is claimed is:

1. A drive device comprising:
a power storage device;
a drive unit including a motor having a three-phase open winding, a first inverter connected to a power line to which the power storage device is connected and connected to one end side of the three-phase open winding, a second inverter connected to the power line on an opposite side of the power storage device from the first inverter and connected to the other end side of the three-phase open winding, a changeover switch provided in the power line between the first and second inverters, a first capacitor connected to the power line on a side of the first inverter from the changeover switch, and a second capacitor connected to the power line on a side of the second inverter from the changeover switch; and
a control device that switchably executes a Y drive, in which the changeover switch is turned off, the other end side of the three-phase open winding is neutralized by the second inverter, and the motor is driven by switching the first inverter, and an H drive, in which the changeover switch is turned on and the motor is driven by switching the first and second inverters, wherein the control device estimates a Y drive gain and an H drive gain that are current gains of a frequency of a main component that affects a current amplitude of the power storage device in the Y drive and the H drive, switches to the H drive when a value obtained by subtracting the H drive gain from the Y drive gain is larger than a first threshold value during the Y drive, and switches to the Y drive when a value obtained by subtracting the Y drive gain from the H drive gain is larger than a second threshold value during the H drive.

2. The drive device according to claim 1, wherein the control device sets the frequency of the main component from twice a carrier frequency of the first and second inverters, three times an electrical frequency of the motor plus or minus the carrier frequency, and six times the electrical frequency based on an operating point of the motor and/or a control mode of the first and second inverters.

3. The drive device according to claim 1, wherein the control device estimates the Y drive gain and the H drive gain by applying the frequency of the main component to a predetermined relationship between a frequency and a gain of the Y drive and the H drive.

4. The drive device according to claim 1, wherein the first and second threshold values are greater than a value of zero.
